(19) United States
(12) Patent Application Publication
(10) Pub. No.: US 2025/0083242 A1
(43) Pub. Date: Mar. 13, 2025

(54) IMPROVEMENTS TO ELECTRICAL DISCHARGE TEXTURING MACHINES

(71) Applicant: Sarclad Limited, Rotherham South Yorkshire (GB)

(72) Inventor: Christopher CHILDS, Rotherham South Yorkshire (GB)

(21) Appl. No.: 18/727,605

(22) PCT Filed: Jan. 10, 2023
(86) PCT No.: PCT/GB2023/050032

§ 371 Date: Jul. 9, 2024

(30) Foreign Application Priority Data
Jan. 10, 2022 (GB) 2200239.8

(51) Int. Cl. B23H 9/04

(52) U.S. Cl. CPC B23H 9/04

(57) ABSTRACT

A power delivery and control system for an EOT machine. The system has component assemblies assembled in a densely packed array. Each component assembly including one or a sub-set of a power delivery system and a servo-controller to control a servomotor assembly linked to, and orientated coaxially with, an electrode.

### FIELD OF THE INVENTION

The present invention relates to improvements to method and apparatus for spark monitoring and modification using Electrical Discharge Texturing (EDT) machining for applying a finish to a surface of a workpiece. In particular the invention relates specifically to an improvement in the configuration of EDT apparatus caused by reducing the electrical distance between the power generation and control electronics and the controlled electrode as well as an alternative configuration allowing independent modification of gap distance between individual electrodes and the surface of a work roll.

### BACKGROUND TO THE INVENTION

An EDT technique is used for applying a textured or matt finish to the surface of a work roll. The work roll is used in the rolling of metallic products to produce on the rolled products a complementary textured or matt finish.

Existing discharge techniques for texturing the surface of an object such as a work roll, otherwise referred to as a mill roll, are discussed in the Applicant's earlier European Patent Numbers EP0294082, EP0304235, EP0373156, EP0371962 and EP2321083.

As described in EP0304235 and EP0371962, electrical discharge apparatus commonly comprises a head with an array of electrodes supported within a block of insulating material, such that each electrode is electrically insulated from its neighbours. The head is moveable, for example by a servomotor, towards and away from the work roll and is supported by a housing. The housing comprises electrical connection for coupling each electrode to an individual source of pulsed direct current.

In use, the electrodes disclosed in EP0304235 protrude into a bath of dielectric fluid in which the surface of the work roll is also immersed. An electric pulse is applied to cause the dielectric fluid to break down so that electricity flows between the electrode head and the work roll surface creating a spark. A spark causes the surface temperature of the roll to rise rapidly and a small area on the roll surface will melt producing a minute crater. Repetition of this process produces a large number of craters, which form the desired roll texture.

Performance of Electrical Discharge Texturing (EDT) machines is determined by changing the distance of the gap between the electrodes and the roll surface using a servomotor control unit. The gap is reduced until the break-down voltage of the dielectric fluid is reached and sparks flow between the electrode/s and the roll surface.

For an electrical discharge apparatus to be efficient it is necessary that as many sparks as possible are created within a given period of time for a given number of applied pulses. However, it has been found that, even when the gap between the electrode and the roll surface is controlled, sparks do not always occur when a pulse is applied. If a spark does not occur, no work is performed on the work roll and the efficiency of the system is reduced.

It is important to monitor the efficiency of each electrode in an array because when multiple electrodes are controlled by a single servomotor control unit it has been found that often one electrode begins to work much harder than its neighbours. The initiation of this increased output to a “dominant” electrode is random and can continue for some time before it will naturally fade out. This can lead to an irregular texture being formed on the work roll surface, a lack of efficiency until the electrode eventually fades out and it can contribute to failure of the pulse-generating electronic connected to the electrodes.

Furthermore, efficiency monitoring is useful to detect other irregularities in EDT machine operation, it has been found that, during normal application of pulsed power to an electrode array in an EDT machine, if the mean voltage between the electrodes and the work roll surface during the sparking period is too low, arcing occurs. This is when the spark created by the pulse of power continues beyond the “on-time” of the pulse, allowing arcing to occur. Arcing damages the surface of the work roll, as a result the work roll cannot be used in a mill. The work roll has to be re-ground and re-textured. This is both costly and time-consuming.

There are further reasons why EDT machines, which use multiple electrodes on a single servomotor, have been found to produce uneven texturing across the length of a roll. As an electrode array moves along the length of a work roll it has been found that in the middle of its path every electrode contributes to the texturing of the roll, because each electrode in the texturing head passes every point along the length. However, when the electrode array is at the end of the work roll the texturing head is brought to a stop and not all the electrodes will pass the end of the work roll. Only the electrode which is nearest to the end of the work roll will contribute to texturing at the end point, with the result that the texturing effect is reduced at the end of the work roll. This is an undesirable effect because use of the work roll in a mill requires an even texturing pattern across the work roll surface.

EP2321083 discloses a control method of an apparatus that improves texturing efficiency of EDT machines; wherein said control method reduces deviation in electrode efficiency and risk of arcing, by modifying spark efficiency of individual electrodes, by adjusting the applied voltage pulses to each of the electrodes in the array, correspondent to the spark efficiency measured by said control method. Therefore, such a control method reduces uneven texturing across the length of a roll, inclusive of texturing at the end of the work roll.

Reliability and accuracy of said control method disclosed in EP2321083 is dependent on latency between the output of measured deviation in electrode efficiency and the corresponding modification of spark efficiency. A factor of latency is resistance found in the cables between the power supply and electrodes. Whereby said resistance reduces both responsiveness and acuity of each voltage pulse applied to the electrodes. Latency therefore reduces the peak count (RPc), work rate and consistency of texturing.

The pulse generated has a voltage of at least 100 volts. When a spark has occurred, the voltage drops to around 20 volts. Power supply units generate heat during the elapsed time period required for texturing the surface of an object such as a work roll. Consequently, power supply units are housed in isolated units with means of air cooling, therefore require a cable connecting the housed power supply and the EDT electrode array; therefore, increasing the length of cable between the power supply and electrode, which is described as the electrical distance. The greater the electrical distance the greater the latency observed.

A limitation to the control method disclosed in EP2321083 is the uneven erosion of electrode tips resultant in variations in spark efficiency. Electrode tip erosion is dependent on power and frequency of applied voltage pulses. Due to presence of a “dominant” electrode in an array, electrodes of the same array require replacement at separate time intervals. This imparts added maintenance time and costs, reducing the total operational time of said array. Furthermore, electrode erosion influences electrode efficiency, consequently propagating greater uneven erosion of electrode tips, when spark efficiency is modified by the aforementioned control method.

The present invention seeks to provide a miniaturised digital servo controller system for improving roll texturing using electrical discharge machines, which alleviates the problems described above by reducing the electrical distance between power supply and electrode and autonomous modification of the gap distance between electrodes and the texturing surface.

Furthermore, the invention seeks to provide an improved EDT machine that includes individual servomotor-electrode assemblies configured with a digital servo-controller, increasing texturing efficiency and reducing the uneven erosion of electrodes.

### Statements of Invention

In one aspect of the invention, there is provided, a power delivery and control system for an EDT machine, the system comprising: a first array of one or more servomotor assemblies connected to and orientated coaxially with one more respective electrodes; and a second array comprising one or more power delivery systems coupled with respective one or more servo-controllers; wherein the first and second arrays are electronically coupled and positioned adjacent each other.

Preferably, each array comprises six component assemblies.

Preferably, the arrays are located in a housing.

Preferably, the housing is divided into upper and lower sections.

Preferably, the upper section of the housing houses the first array.

Preferably, the lower section of the housing houses the second array.

Preferably, the second array controls and provides power to the first array in a closed-loop system for constant current power delivery.

Preferably, at least the one or more power delivery systems of the second array are located on a liquid cooled plate.

Preferably, the one or more servomotor assemblies include a servomotor to control movement of a guide tube, which in turn controls the movement and positioning of the electrode.

Preferably, the one or more servomotor assemblies include an anti-backlash linear guide module.

Preferably, the one or more servo-controllers include software to control the sparking duration of a respective electrode.

Preferably, the first array has at least two component assemblies aligned in such a way as to be convergent.

Preferably, second array has at least two component assemblies aligned generally parallel.

Preferably, the position and power delivery of the one or more electrode is controlled and altered by the respective one or more servo-controller and power delivery system.

Preferably, the housing is securable to an EDT machine in such a way that the one or more electrodes are controlled and activated to provide texture to a working roll.

Miniaturisation of a digital power delivery and control system for an EDT machine, the system having a component assembly in a densely packed array to reduce electrical distance and produce a more uniform texturing effect.

The invention also provides a method of monitoring voltage parameters are monitoring voltage parameters for an EDT machine, comprising the steps of counting the number of voltage pulses applied; counting the number of voltage pulses applied to each electrode which drop to below a threshold voltage; calculating the proportion of voltage pulses applied to each electrode which drop to below the threshold voltage to the number of voltage pulses applied to yield an efficiency measurement for the corresponding electrode; and outputting the efficiency measurement for said electrode.

By measuring the spark efficiency, a user is given accurate feedback concerning the performance of the EDT machine, allowing adjustments to be made to for optimisation.

### BRIEF DESCRIPTION OF DRAWINGS

Embodiments of the invention will now be described by way of example with reference to the accompanying diagrammatic drawings, in which:

FIG. 1 shows an improved control assembly for an EDT machine constructed in accordance with a first embodiment of the invention;

FIG. 2 shows a power and control system for the assembly of FIG. 1;

FIG. 3 shows an individual servomotor assembly of FIG. 2; and

FIG. 4 shows an improved control assembly for an EDT machine constructed in accordance with a second embodiment of the invention.

### DETAILED DESCRIPTION OF THE INVENTION

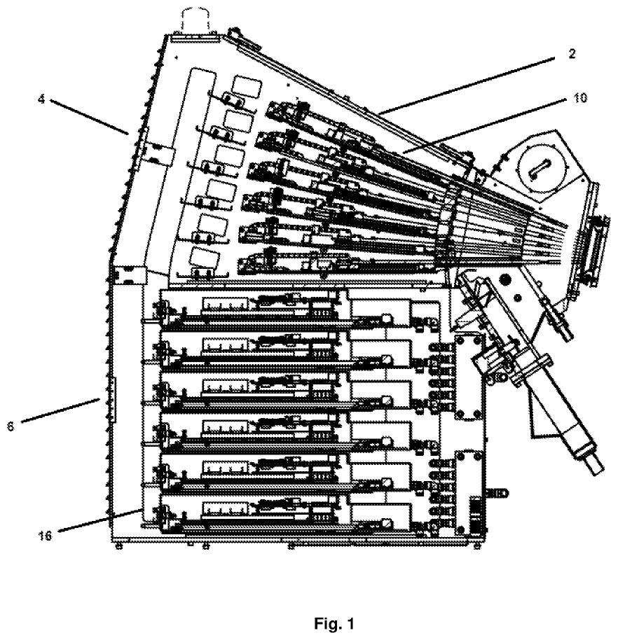

An improved control assembly for an EDT machine is shown in FIG. 1. All the control components of the assembly are located in a single housing 2 which divided into upper and lower sections 4, 6.

Alternatively different components may be located in separate housings secured to, or otherwise adjacent to, each other.

The upper section 4 of the housing 2 houses a plurality of servomotors assemblies 8 densely packed into a first array 10.

The lower section 6 of the housing 2 houses a plurality of power delivery systems 12 and digital servo control systems 14 densely packed into a second array 16.

By “array” it is meant a set of components that are placed in an ordered configuration.

The relative locations of the first and second arrays 10, 16 within the housing 2 means that they are close to each other, being adjacent.

Although FIG. 1 appears to show the housing sections 4, 6 side by side, this is done for illustrative purposes, to show the component parts clearly, and in fact the upper section 4 is directly above the lower section 6.

The first and second arrays 10, 16 each include a plurality of component assemblies, which include a servomotor assembly 8, a power delivery system 12 and a digital servo controller 14. In the embodiment shown there are six assemblies longitudinally adjacent to each other. In the case of the second array 16 the component assemblies are substantially parallel. In the case of the first array 10 the component assemblies are convergent. Any number of component assemblies may be used, depending on the space limitations.

The housing 2 is secured at an appropriate place on the EDT machine to provide texturing to a work roll.

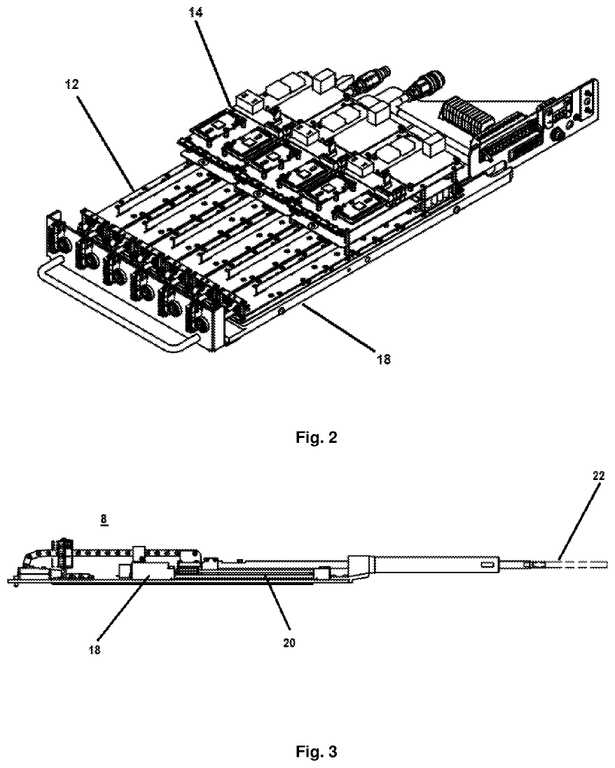

The second array 16 is shown in FIG. 2. The digital servo-controller 14 provides the overall control and power delivery of the assembly and provides closed-loop constant current power delivery.

The power delivery systems 12 are located on a liquid cooled plate 18, for example one provided by Wakefield-Vette™, to provide cooling to the electronics sufficient for the power density required for high power outputs.

The second array 16 is linked to the first array 10 through a connection optimised for low LCR (Inductance, Capacitance and Resistance).

The greatly reduced distance between the power, controller and the electrodes reduces latency and improves efficiency of the electrode assembly.

A servomotor assembly 8 of the first array 10 is shown in FIG. 3. The assembly 8 includes a servomotor 18 with an anti-backlash linear guide module to control movement of a guide tube 20 which, in turn, controls the movement and positioning of an electrode 22.

The servomotor 18 is orientated coaxially with the electrode 22.

The servomotor assembly 8 is designed and constructed to have a moving mass as low as possible to allow the system to exhibit highly dynamic behaviour.

Each power and servo control system 10, 12 controls the position and power delivery of a respective electrode 22.

The servo-controller 14 includes software to control the sparking duration of the respective electrode 22 to improve the consistency of energy delivered by each spark.

As can be seen in FIG. 1, each servomotor assembly 8 is provided in a densely packed array with assemblies convergent towards the electrodes 22.

The position and power delivery of an individual electrode 22 can be controlled and altered by the respective servo-controller 14 and power delivery system 12 of the second array 16.

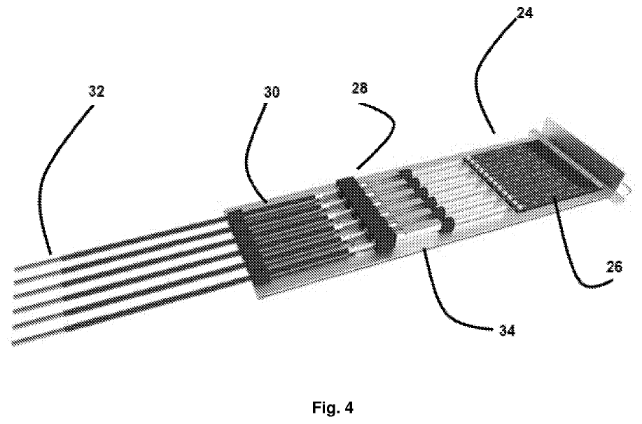

FIG. 4 illustrates a second embodiment of the invention. In this embodiment, the system components are densely pack into an array in linear formations, which are located within a housing. A power and digital servo control system 24 is located at one end of the array, located close to a servomotor and power delivery system 26.

The servomotor system 26 comprises a plurality of linear servomotors 28 to control movement of carbon fibre guide tubes 30 which, in turn, provide fast and precise positioning of each electrode 32. The components are located on a liquid cooled plate 34, as previously described.

The gap distance between the electrode 22 and the textured surface can be increased or decreased depending on the controlled power delivery (frequency and length of electrical pulses applied to each electrode), with respect to the desired spark efficiency.

The construction and assembly described above allows for miniaturisation of the control system, to reduce the distance between the electrodes and the power delivery and servo control systems, thereby enhancing the performance and efficiency of the EDT machine.

Voltage parameters are monitored by counting the number of voltage pulses applied; counting the number of voltage pulses applied to each electrode which drop to below a threshold voltage; calculating the proportion of voltage pulses applied to each electrode which drop to below the threshold voltage to the number of voltage pulses applied to yield an efficiency measurement for the corresponding electrode; and outputting the efficiency measurement for said electrode.

By measuring the spark efficiency, a user is given accurate feedback concerning the performance of the EDT machine, allowing adjustments to be made to for optimisation.

The method of measuring efficiency can be automated to allow direct feedback to be inputted into the operational parameters of the machine whereby automatic adjustments are made in response to the efficiency input.

Furthermore, automation is able to exhibit reliability and accuracy in action, due to a reduced electrical distance between the power supply, controllers and electrodes. This may allow a user to predict arcing and to achieve an evenly textured pattern across the work roll surface.

The voltage pulses applied to the or each electrode may be adjusted by reducing or stopping the power applied to the or each electrode for a set period of time.

1. A power delivery and control system for an Electrical Discharge Testing (EDT) machine, the system comprising:
a first array of one or more servomotor assemblies connected to and orientated coaxially with one more respective electrodes; and
a second array comprising one or more power delivery systems coupled with respective one or more servo-controllers;
wherein the first and second arrays are electronically coupled and positioned adjacent each other.

2. The system of claim 1, wherein each array comprises six component assemblies.

3. The system of claim 1, wherein the arrays are located in a housing.

4. The system of claim 3, wherein the housing is divided into upper and lower sections.

5. The system of claim 4, wherein the upper section of the housing houses the first array.

6. The system of claim 5, wherein the lower section of the housing houses the second array.

7. The system of claim 1, wherein the second array controls and provides power to the first array in a closed-loop system for constant current power delivery.

8. The system of claim 1, wherein at least the one or more power delivery systems of the second array are located on a liquid cooled plate.

9. The system of claim 1, wherein the one or more servomotor assemblies include a servomotor to control movement of a guide tube, which in turn controls the movement and positioning of the electrode.

10. The system of claim 1, wherein the one or more servomotor assemblies include an anti-backlash linear guide module.

11. The system of claim 1, wherein the one or more servo-controllers include software to control the sparking duration of a respective electrode.

12. The system of claim 1, wherein first array has at least two component assemblies aligned in such a way as to be convergent.

13. The system of claim 1, wherein second array has at least two component assemblies aligned generally parallel.

14. The system of claim 1, wherein the position and power delivery of the one or more electrode is controlled and altered by the respective one or more servo-controller and power delivery system.

15. The system of claim 3, wherein the housing is securable to an EDT machine in such a way that the one or more electrodes are controlled and activated to provide texture to a working roll.
